(19) United States
(12) Patent Application Publication
(10) Pub. No.: US 2006/0189191 A1
(43) Pub. Date: Aug. 24, 2006

(54) Block sealing system

(76) Inventors: Thomas Drescher, Hueckeswagen (DE); Klaus Storandt, Witten (DE); Udo Wenske, Wuppertal (DE)

Correspondence Address: DELPHI TECHNOLOGIES, INC., M/C 480-410-202, PO BOX 5052, TROY, MI, 48007, US

(21) Appl. No.: 10/541,723

(22) PCT Filed: Jan. 7, 2004
(86) PCT No.: PCT/EP04/00048

§ 371 Date: Jul. 7, 2005

(30) Foreign Application Priority Data
Jan. 8, 2003 (DE) 103 00 264.2

(51) Int. Cl. H01R 13/52

(52) U.S. Cl. 439/271

(57) ABSTRACT

A block sealing system for an electric connector comprises a block seal insertable into the connector housing through which seal when assembling the electric connector at least one electric contact is plugged through or pierced through. In doing so the block seal in the region of any particular electric contact viewed in the contact plug-in direction is divided into at least two plug-in regions having a spacing from one another in the contact plug-in direction. Expediently, each plug-in region for any assigned contact is provided with an opening whose maximum diameter is preferably less than the maximum transverse measurement of the contact in question and in particular less than the external diameter of the lead in question on which the contact is fitted. The actual sealing ensues in the region of the lead.

The invention relates to a block sealing system for an electric connector having a block seal which is insertable into the connector housing and through which when assembling the electric connector at least one electric contact is plugged or pierced through. It further relates to an electric connector having such a block sealing system.

In connectors having conventional block sealing systems of the type identified at the outset there is the risk when fitting them with the electric contacts that the seal will be damaged or even destroyed due to the relatively high plug-in forces occurring on piercing through the block seal. A key factor in these problems is in particular the circumstance that sealing material albeit in relatively small amount can be displaced, from which correspondingly relatively high plug-in forces result. The high plug-in forces also entail inter alia the risk that the leads provided with the contacts readily break off and when establishing the desired electric connection the contacts can no longer be correctly plugged in.

The underlying object of the invention is to provide an improved block sealing system and an improved electric connector of the type identified at the outset in which the problems previously referred to are eliminated in the simplest possible manner.

With regard to the block sealing system this task is solved according to the invention in that in the region of each electric contact the block seal viewed in the contact plug-in direction is divided into at least two plug-in regions having a spacing from one another in the contact plug-in direction. Expediently, each plug-in region is provided with an opening for each associated contact whose maximum diameter is preferably less than the maximum transverse measurement of the contact in question and in particular less than the external diameter of the lead in question on which the contact is provided or fitted. The actual sealing takes place in the region of the lead. When a contact is plugged through any particular opening this opening is preferably only widened. In principle, however, embodiments are also conceivable in which no such openings are provided. In this case the contacts are pierced through the plug-in regions in question.

Due to this construction the plug-in forces occurring on plugging each contact through the block seal or on piercing the block seal with the electric contacts are reduced to a minimum. Correspondingly, the risk of any damage or destruction of the seal is also minimised. In the same fashion the stress increment factor is reduced to a minimum so that it is also ruled out for the seal to become permeable when the contacts are inserted. The block sealing system according to the invention can be employed for all sealed connectors. As a general rule the connector in question can be assembled as hitherto but the contacts can be more easily plugged in. When the contacts are plugged in no excess sealing material need any longer be displaced. Only that sealing material is displaced which is needed for sealing at the lead or cable in question.

The connector in question can be completely preassembled. Another assembly step in the later use of the connector in question is not necessary.

In the publications EP 1 251 616 A1, WO 97/41474 and WO 89/10021 sealing systems are already disclosed in which the lead ends in question are surrounded only in some regions by the sealing material in question. These, however, are each two-part sealing systems whose halves are brought together to bring about the sealing function.

Expediently, in the region of each electric contact viewed in the contact plug-in direction the block seal is divided into at least three plug-in regions having a spacing from one another in the contact plug-in direction.

A preferred practical embodiment of the block sealing system according to the invention is characterised in that the block seal as a whole is divided into at least two or at least three layers and the plug-in regions having a spacing from one another in the contact plug-in direction are distributed over these layers.

Thus, in this case a sandwich-like structure is obtained in which instead of a single uniform block seal a plurality of individual block seals (layers) is provided. In doing so these layers of the block seal preferably possess the same geometry. The different sealing layers can be assembled successively in the connector housing and finally lie on top of one another like a sandwich.

The plug-in regions each associated with at least one electric contact are each advantageously constructed like a membrane or lips.

It is also particularly advantageous for the plug-in regions each associated with at least one electric contact to have the same geometry or contour.

In a preferred practical embodiment of the sealing system according to the invention the plug-in regions each associated with at least one electric contact possess an angular contour.

By this inner sealing contour being angular instead of round the plug-in regions constructed, for example, like a membrane or lips have more free space for movement when the contacts are inserted, as a result of which the load on the sealing material is correspondingly reduced so that in the final analysis damage to the seal is avoided. As a result of the plug-in regions of the block seal being in particular like a membrane or lips the block sealing system as a whole is given a more flexible structure.

Preferably, the plug-in regions each associated with at least one electric contact each have a square contour.

The plug-in regions each associated with at least one electric contact or the various layers of the block seal can consist at least in part of different materials, possess at least in part a different Shore hardness, contain at least in part different additives and/or have at least in part different dimensions. In this way the block sealing system can be adapted in optimum manner to different requirements on the part of the user.

By the different layers of the block seal being insertable in the manner of a sandwich into the connector housing a sandwich-like structure for the block sealing system is finally obtained.

The electric contacts can be plugged in in the block seal in multiple rows or in one row.

In certain cases it may be expedient for any particular plug-in region to have assigned to it only one electric contact. When this is done the plug-in region is provided with only one opening. In principle, however, it is also conceivable in this case to have a version without opening.

In a useful, practical embodiment a pocket free of sealing material whose cross-section diminishes or increases in the plug-in direction is provided ahead of and/or behind any particular plug-in region viewed in the contact plug-in direction.

The opening of any particular plug-in region can be arranged centrally when viewed in the plug-in direction and over the thickness of the layer in question.

It is also particularly advantageous for the opening of each plug-in region to be arranged centrally in a plane perpendicular to the plug-in direction and viewed over the plug-in region in question.

The electric connectors according to the invention is characterised in that it is provided with a block sealing system according to the invention. At the same time it can, in particular, be a plug-in connector.

The invention can be applied in all sealed connectors fitted with multiple or single rows of contacts and in particular in all so-called tangles contacts (e.g. BTS, GT, MTS-B).

### The invention is explained in more detail below on the basis of exemplified embodiments with reference to the drawing. The latter shows:

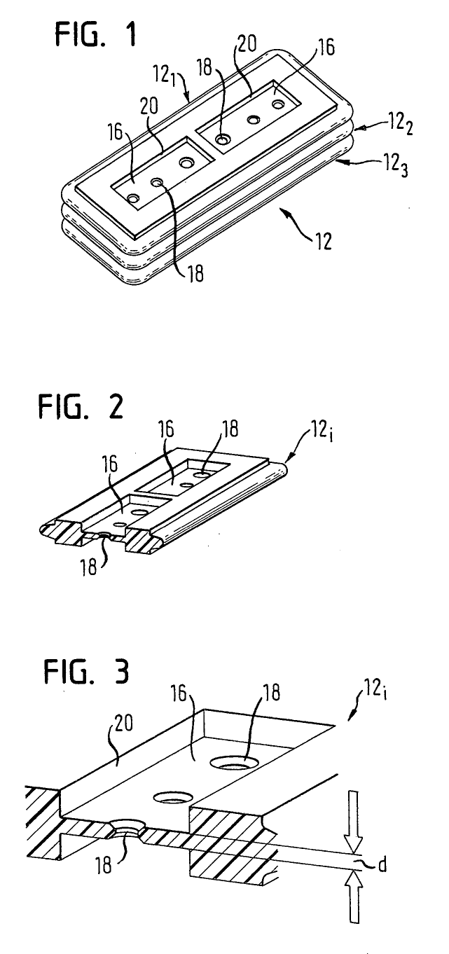

FIG. 1 a schematic view in perspective of a block seal divided into three layers in block sealing system for an electric connector;

FIG. 2 a schematic sectional view in perspective of a single layer of the block seal shown in FIG. 1;

FIG. 3 an enlarged illustration of part of the layer shown in FIG. 2;

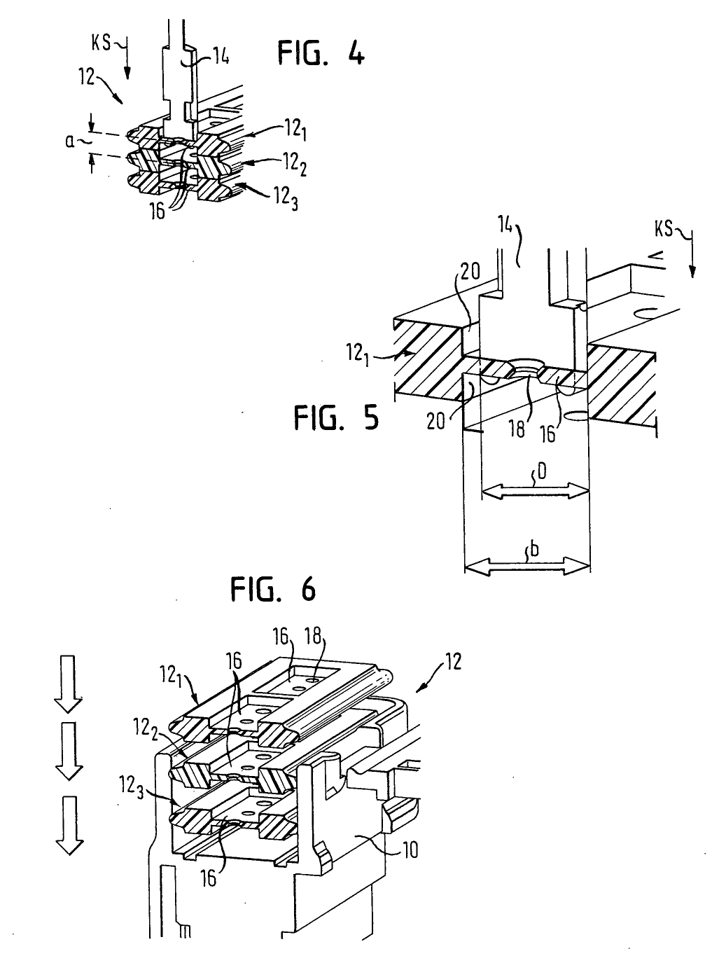

FIG. 4 a schematic sectional view in perspective of the three layers of the block seal in FIG. 1 arranged on top of one another like a sandwich, wherein above this an electric contact piercing through these layers is illustrated;

FIG. 5 an enlarged illustration of a plug-in region to be pierced by the contact to be inserted through one of the layers shown in FIG. 4;

FIG. 6 an exploded perspective view in section of the three layers to be inserted into the connector housing;

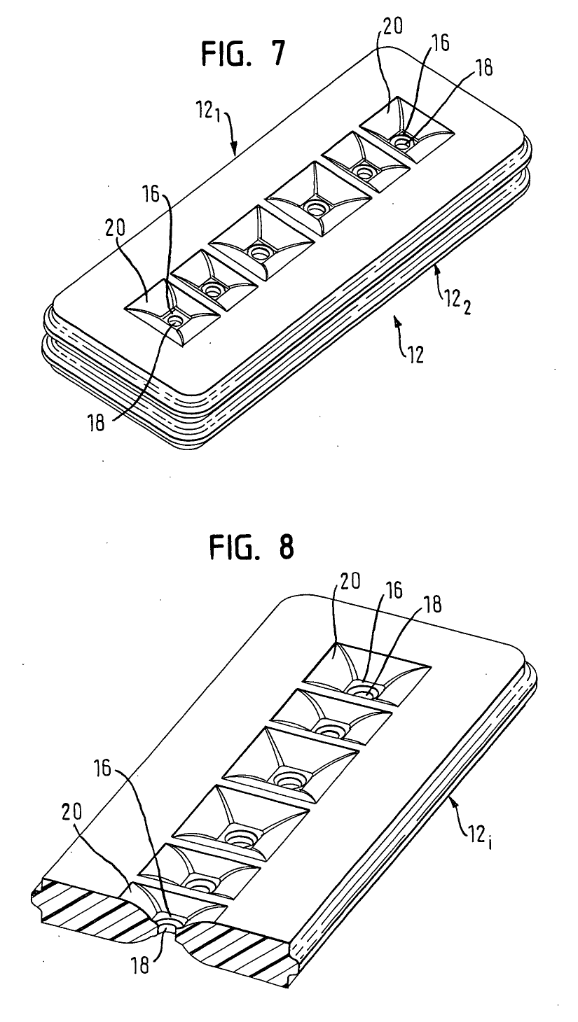

FIG. 7 a schematic view in perspective of another embodiment of a block seal divided at least into two layers;

FIG. 8 a schematic perspective view in section of a single layer of the block seal shown in FIG. 1;

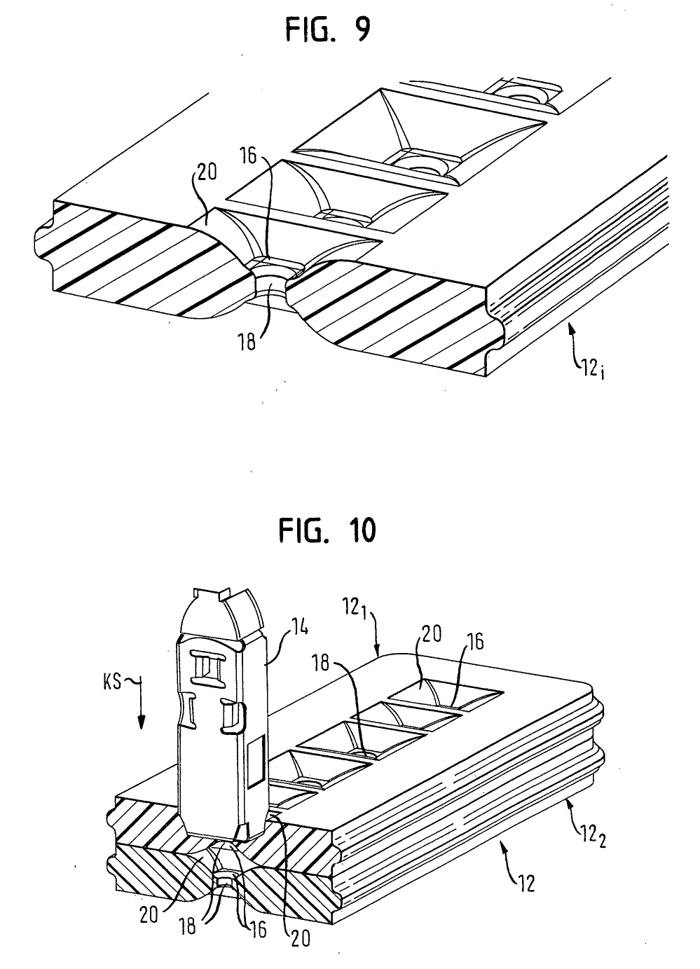

FIG. 9 an enlarged illustration of part of the layer shown in FIG. 8;

FIG. 10 a schematic perspective view in section of the two layers arranged on top of one another in the manner of a sandwich in the block seal shown in FIG. 7, wherein on top of this once again an electric contact piercing through these layers is illustrated; and

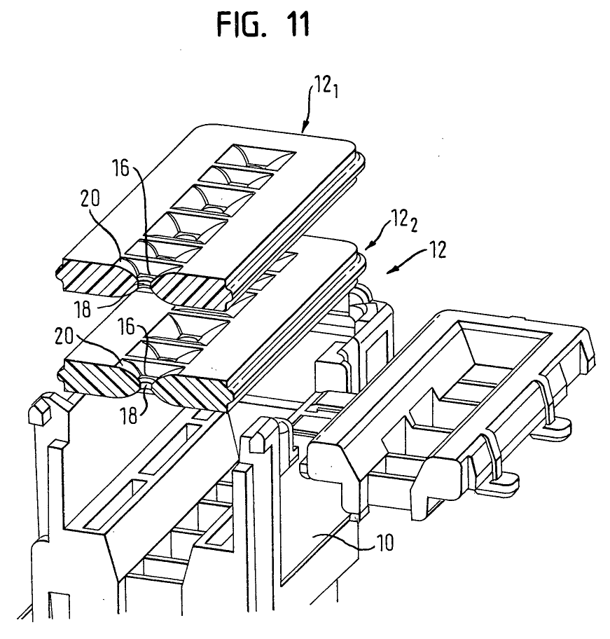

FIG. 11 an exploded illustration in section of the two layers of the block seal in FIG. 7 to be inserted into the distributor housing.

In FIGS. 1 to 6 an exemplified embodiment of block sealing system for an electric connector is illustrated which, by way of example, may be a plug-in connector.

The block sealing system comprises a block seal 12 which is insertable into the connector housing 10 (cf in particular FIG. 6) and through which on assembly of the electric connector at least one electric contact 14 (cf FIGS. 4 and 5) can be plugged through or pierced through.

In the region of any particular electric contact 14 viewed in the contact plug-in direction KS (cf FIGS. 4 and 5) the block seal 12 is divided into at least two plug-in regions 16 having a spacing a relative to one another in the contact plug-in direction KS.

In the embodiment reproduced in FIGS. 1 to 6 the block seal 12 is divided in the region of any particular electric contact 14 into three such plug-in regions 16 having a respective spacing a with respect to one another in each case.

As may be seen in FIG. 3, for example, the plug-in regions 16 each assigned to at least one electric contact 14 are each constructed like a membrane or lips.

In the present case any particular plug-in region 16 is provided with an opening 18 for each associated contact 14, each opening in the two present embodiments having a circular cross-section. The diameter of these openings 18 is preferably less than the maximum transverse measurement and less than the diagonal measurement D of the contact 14 in question and in particular less than the external diameter of the lead in question on which the contact 14 is provided or fitted. The actual sealing ensues in the region of the lead. On plugging a contact 14 through an associated opening 18 this opening 18 as a rule is merely widened. Piercing through can occur in particular when no such opening 18 is present.

In the present exemplified embodiment according to FIGS. 1 to 6 three contacts 14 are assigned in each case to any particular plug-in region 16. In principle more than three contacts 14 or only one such electric contact 14 can be assigned in each case to such a plug-in region 16.

At the same time the plug-in regions 16 assigned in each case to at least one electric contact 14 can have the same geometry or contour. In the present case these plug-in regions 16 each have an angular contour which here by way of example is rectangular (cf FIG. 1 for example) but, for example, in the case of a plug-in region 16 assigned to only contact 14 it may also be square by way of example.

The electric contacts 14 may by way of example be plugged in in the block seal 12 in multiple rows or in one row.

In the embodiment of the block sealing system presented in FIGS. 1 to 6 the block seal 12 is divided by way of example into three layers 12₁-12₃, wherein the plug-in regions 16 having a respective spacing a from one another in the contact plug-in direction KS are distributed over these layers 12₁-12₃.

As may be seen with reference to FIGS. 1 to 6 the layers 12₁-12₃ of the block seal 12 have the same geometry.

As may be seen in particular with reference to FIG. 6 the different layers 12₁-12₃ of the block seal are inserted in the manner of a sandwich into the connector housing 10.

The plug-in regions 16 each assigned to at least one electric contact 14 or the different layers 12₁-12₃ of the block seal 12 can consist at least in part of different materials, have at least in part a different Shore hardness, contain at least in part different additives and/or possess at least in part different dimensions.

As may be seen by way of example with reference to FIGS. 1 to 5 pockets 20 free of sealing material are produced above and below the respective membrane-like or tongue-like plug-in regions 16. The width b of these pockets 20 and hence the width of the associated plug-in region 16 can be, for example, in the region of 4.5 mm. The thickness d (cf FIG. 3 for example) of each plug-in region 16 can by way of example amount to approximately 0.5 mm.

The diagonal measurement D (cf FIG. 5 for example) of any particular electric contact 14 can lie by way of example in the region of approximately 4 mm.

The diameter of any particular opening 18 can lie by way of example in the region of 2.8 mm.

In principle, however, dimensions other than those specified are also conceivable.

The spacings a between the plug-in regions 16 following one another in the plug-in direction KS can be the same or, at least in part, different. The thicknesses d also of the plug-in regions following one another in the plug-in direction KS can again be the same or, at least in part, different. The same applies correspondingly also to the dimensions of the intermediate spaces or pockets 20 free of sealing material.

FIG. 7 shows in a schematic view in perspective another version of a subdivided block seal 12 which in the present case is divided by way of example into two layers 121, 122.

In the present case any particular plug-in region 16 is associated with only one electric contact 14 (cf FIG. 10) or provided with only one opening 18.

Viewed in the contact plug-in direction KS (cf FIG. 10), in front of and/or behind any particular plug-in region 16 a pocket 20 free of sealing material is once again provided. In the present case, however, these pockets 20 each have a cross-section which tapers towards the opening 18 (cf in particular FIGS. 8-10).

As may be seen with reference to FIGS. 7 to 11 the opening 18 of each plug-in region 16 viewed both in the plug-in direction KS and over the thickness of the layer 12₁, 12₂ in question and also viewed in a plane perpendicular to the plug-in direction KS and over the plug-in region 16 in question is arranged centrally in each case.

FIG. 8 shows a sectional view in perspective of a single layer 12ᵢ of the block seal 12 shown in FIG. 7. In FIG. 9 a part of the layer 12ᵢ shown in FIG. 8 is reproduced in enlarged detail.

FIG. 10 shows a schematic sectional view in perspective of the two layers 12₁, 12₂ arranged on top of one another in the manner of a sandwich of the block seal 12 shown in FIG. 7, wherein above this an electric contact 14 plugged through these layers 12₁, 12₂ is once again illustrated.

The block seal 12 is again insertable into a connector housing 10 (cf FIG. 11). FIG. 11 shows an exploded sectional view in perspective of the two layers 121, 122 of the block seal 12 shown in FIG. 7 to be inserted into the connector housing 10.

### List of Reference Symbols

10 Connector housing
12 Block seal
12₁ Layer
12₂ Layer
12₃ Layer
14 Electric contact
16 Plug-in region
18 opening
20 Pocket
a Spacing
b Width
c Thickness
D Diagonal contact measurement
KS Contact plug-in direction

1. Block sealing system for an electric connector having a block seal insertable into the connector housing, through which seal, when assembling the electric connector, at least one electric contact is plugged through or pierced through, wherein the block seal, in the region of any particular electric contact viewed in the contact plug-in direction, is divided into at least two plug-in regions having a spacing from one another in the contact plug-in direction.

2. Block sealing system according to claim 1, wherein, for each assigned contact, each plug-in region is provided with an opening whose maximum diameter is preferably less than the maximum transverse measurement of the contact in question and in particular less than the external diameter of the lead in question on which the contact is provided.

3. Block sealing system according to claim 1, wherein the block seal in the region of any particular electric contact viewed in the contact plug-in direction is divided into at least three plug-in regions having a spacing from one another in the contact plug-in direction.

4. Block sealing system according to claim 1, wherein the block seal as a whole is divided into at least two or at least three layers, and the plug-in regions having a spacing from one another in the contact plug-in direction are distributed over these layers.

5. Block sealing system according to claim 4, wherein the layers of the block seal have the same geometry.

6. Block sealing system according to claim 1, wherein the plug-in regions each assigned to at least one electric contact are each constructed like a membrane or lips.

7. Block sealing system according to claim 1, wherein the plug-in regions each assigned to at least one electric contact have the same geometry or contour.

8. Block sealing system according to claim 1, wherein the plug-in regions each assigned to at least one electric contact have an angular contour.

9. Block sealing system according to claim 8, wherein the plug-in regions each assigned to at least one electric contact have a square contour.

10. Block sealing system according to claim 1, wherein the plug-in regions each assigned to at least one electric contact or the various layers of the block seal consist at least in part of different materials.

11. Block sealing system according to claim 1, wherein the plug-in regions each assigned to at least one electric contact or the various layers of the block seal have at least in part a different Shore hardness.

12. Block sealing system according to claim 1, wherein the plug-in regions each assigned to at least one electric contact or the various layers of the block seal contain at least in part different additives.

13. Block sealing system according to claim 1, wherein the plug-in regions each assigned to at least one electric contact or the various layers of the block seal possess at least in part different dimensions.

14. Block sealing system according to claim 1, wherein the various layers of the block seal are insertable in the manner of a sandwich into the connector housing.

15. Block sealing system according to claim 1, wherein the electric contacts in the block seal are plugged in multiple rows.

16. Block sealing system according to claim 1, wherein the electric contacts in the block seal are plugged in one row.

17. Block sealing system according to claim 1, wherein any particular plug-in region is assigned to only one electric contact.

18. Block sealing system according to claim 17, wherein the plug-in region is provided with only one opening.

19. Block sealing system according to claim 1, wherein, in front of and/or behind any particular plug-in region viewed in the contact plug-in direction, a pocket free of sealing material is provided whose cross-section diminishes or enlarges in the plug-in direction.

20. Block sealing system according to claim 17, wherein the opening of each plug-in region viewed in the plug-in direction over the thickness of the layer question is arranged centrally.

21. Block sealing system according to claim 17, wherein the opening of each plug-in region viewed in a plane perpendicular to the plug-in direction and over the plug-in region in question is arranged centrally.

22. Electric connector having a block sealing system according to claim 1.
